(19) United States
(12) Patent Application Publication
(10) Pub. No.: US 2022/0207583 A1
(43) Pub. Date: Jun. 30, 2022

(54) Customized Cosmetics and Meal Ingredients

(71) Applicant: Addriane Irizarry, Edison, NJ (US)

(72) Inventor: Addriane Irizarry, Edison, NJ (US)

(21) Appl. No.: 17/564,127

(22) Filed: Dec. 28, 2021

Related U.S. Application Data
(60) Provisional application No. 63/131,251, filed on Dec. 28, 2020.

(51) Int. Cl. G06Q 30/06

(52) U.S. Cl. CPC G06Q 30/0621

(57) ABSTRACT

A method for providing customizable meal Ingredient preparation and delivery, and beauty service scheduling, to customers. The source of ingredient is not important and may be, an online recipe, the customer's recipe, a customer's friends recipe, a customer's family's recipe, or any other source. The customer may choose exactly the ingredients they want with no restrictions or pre-set meal ideas, no restriction on amounts, no restrictions on appearance, and may substitute ingredients for common ingredients. The customer may specify how an ingredient is cleaned, cut, trimmed, amount of spices and fresh herbs, avoiding wasted ingredients that the customer has no interest in using. Customers may further access the beauty service scheduling to schedule several beauty services provided confidently and timely. The services may be scheduled for a single fixed location, a mobile provider, or at the customer's home.

### CROSS-REFERENCE TO RELATED APPLICATIONS

The present application claims the priority of U.S. Provisional Patent Application Ser. No. 63/131,251 filed Dec. 28, 2020, which application is incorporated in its entirety herein by reference.

### BACKGROUND OF THE INVENTION

The present invention relates to cosmetics and meal ingredient kits, and in particular to customizing cosmetics and meal ingredients based on customer feedback.

Customers want more convenience in every part of life. In the past, the idea of providing meal kits for families was not something that was of interest to most people, even in the food industry. However, customers desire the best result with least amount of effort., and more people would cook if obtaining ingredients was not a time-consuming process.

Customers also desire beauty services which complement their needs but have limited time to schedule and obtain the services.

Unfortunately, preferences vary widely between customers, and both obtaining meal ingredients and scheduling beauty services are generally not ideal for individual customers.

### BRIEF SUMMARY OF THE INVENTION

The present invention addresses the above and other needs by providing customizable meal Ingredient preparation & delivery and beauty service scheduling to customers. The source of ingredients may be an online recipe, a customer's recipe, a customer's friends recipe, a customer's family's recipe, or any other source. The customer may choose the exact ingredients they want with no restrictions or pre-set meal ideas, no restriction on amounts, no restrictions on appearance, and may substitute ingredients for common ingredients. The customer may specify how an ingredient is cleaned, cut, trimmed, amount of spices and fresh herbs, avoiding wasted ingredients that the customer has no interest in using. Customers may further access the beauty service scheduling to schedule several beauty services provided confidently and timely. The services may be scheduled for a single fixed location, a mobile provider, or at the customer's home.

In accordance with one aspect of the invention, there is provided a method for obtaining ingredients for meals. Customers choose from different options. Customers may further customization ingredient lists initially, or after sampling sample ingredients. Connections between recipes with ingredients in a customer's refrigerator or suggesting a recipe may be provided and selected items added to an order delivered to the customer's home.

In accordance with another aspect of the invention, a customer may select any recipe in the world or the customer's creations and have the ingredients provided in the amounts request. The customer may also specify an existing recipe but with more or less spice.

In accordance with yet another aspect of the invention, a software application is provided allowing customers to submit a customized recipe. Amounts of each ingredient are determined, how the ingredients are cleaned, cut, sliced, diced, julienned, pre-marinated, etc. The software application takes the ingredient request order, the ingredients are collected and delivered to the customer. The customer is then able to immediately start cooking the meal they created, in the way they most enjoy it, in the amount they wanted and without requiring shopping or ingredient preparation.

In accordance with still another aspect of the invention, there is provided a system for providing beauty services. Customers provide a list of desired services or select services from a menu.

In accordance with another aspect of the invention, there is provided a method for providing individual beauty services that can be chosen by the customer. Services from individual cosmologists, stylist, aestheticians, nail technicians, massage therapists, etc. may be selected. The customer may choose as many services as they want from individual beauty specialist's who have been vetted. Services may be scheduled to provide the requested services all within a specified time-frame and in the order that is most efficient for the customer, based on the services chosen, avoiding multiple trips to service providers.

In accordance with yet another aspect of the invention, there is provided a method for providing cosmetics. The customer may provide recipes for one or more cosmetic products, receive samples, and modify recipes. The ingredients for each product will be pre-tested in all combinations available to ensure effectiveness.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A shows a method for customizable main meal Ingredient preparation & delivery according to the present invention.

FIG. 1B continues the method according for customizable main meal Ingredient preparation & delivery according to the present invention.

FIG. 2 shows a method for customizable side dish Ingredients and additional items according to the present invention.

FIG. 3 shows a method of adjusting ingredients according to the present invention.

FIG. 4 shows a method of adjusting ingredients based on sample ingredient according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

The method of the present invention allows a customer to enter any food ingredient to be prepared to the customers specifications and delivered to the customers home or desired location, or cosmetic services provided at a commercial establishment.

### Meal Ingredients

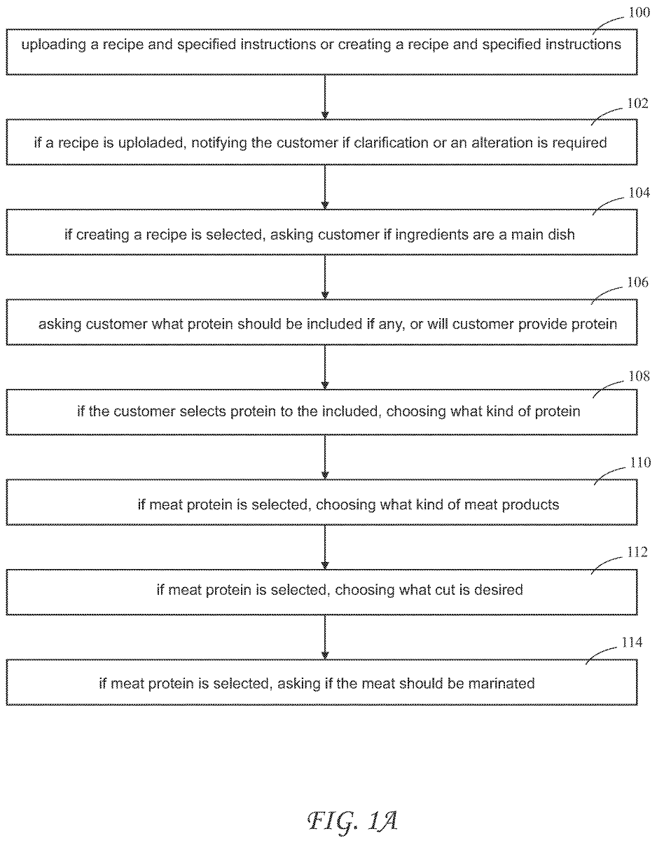

FIGS. 1A and 1B describe a method for customizable main meal Ingredient preparation & delivery. The method for main meal ingredients includes:

uploading a recipe and specified instructions or creating a recipe and specified instructions at step 100;
if a recipe is unloaded, notifying the customer if clarification or an alteration is required at step 102; and
if creating a recipe is selected, asking customer if ingredients are a main dish at step 104.

If ingredients are a main dish, the method further includes steps of:

asking customer what protein should be included if any, or will customer provide protein at step 106;
if the customer selects protein to the included, choosing what kind of protein at step 108, for example, providing a drop down menu including: beef; chicken; pork; seafood; vegetables; and vegan.

If meat protein is selected:

asking what kind of meat products at step 110, for example: beef, chicken, pork, seafood, for example: beef; steak; ground beef; brisket; tri-tip; chuck roast, etc., chicken breast; thighs; kabob chunks, etc;
asking what cut is desired at step 112, for example: whole, sliced, chopped, chunks, shredded, etc. (if selection is self-explanatory then not necessary);
asking if the meat should be marinated at step 114;
if marination is selected, choosing the marinade ingredients at step 116, for example: lime, garlic, cilantro, onion (red, yellow, white) etc.;
asking how long marinated for; and
if no marination, skipping to seasonings.

Asking if the meat should be seasoned at step 118. If seasoning is selected, choosing the kind of seasoning at step 120, for example: salt; type of salts, pepper; types of pepper; garlic; type of garlic (e.g., fresh garlic, grated garlic, diced garlic, crushed garlic, whole garlic, powdered garlic, dried/dehydrated garlic); bell peppers should be included; hot peppers; basil, fresh or dried; parsley, fresh or dried; oregano, fresh, dried; Italian seasoning; paprika; cayenne; onion; fresh onion; onion powder, dehydrated onion; onion; red, white onion; yellow onion; chopped fresh onions; sliced fresh onions; garlic; fresh garlic; grated garlic; diced garlic; crushed garlic; whole garlic; powdered garlic; dried/dehydrated garlic; shallots; chopped shallots; and ed whole shallots.

If a non-meat replacement protein is selected, for example, vegetable protein, tofu, boca burger, impossible burger, or any vegetarian ground beef substitute, select a seasoning or marinate as above.

The method further includes steps of asking if dry goods should be included at step 122, if dry goods are selected, choosing the kind of dry goods at step 124, for example: flour; almond flour; coconut; flour; flaxseed; baking soda, baking powder; flour; almond flour; coconut flour; flaxseed; baking soda; baking powder; and sugar.

The method further includes steps of asking if vegetables should be included in the main dish at step 126, if yes, what kind of the vegetables, for example: spinach; broccoli; cauliflower; eggplant; zucchini; squash, and the like. If vegetables are included, asking if the vegetables should be seasoned or marinated at step 128. If vegetables are included, asking if the vegetables should be seasoned and choosing which seasonings should be included at step 130, for example: salt and types of salts, pepper and types of pepper; garlic and types of garlic, for example: fresh, grated, diced, crushed, whole, powdered, dried/dehydrated; bell peppers; hot peppers; basil (fresh or dried); parsley (fresh or dried), oregano (fresh or dried); Italian seasoning; paprika; cayenne; fresh onions; onion powder, dehydrated onions; red, white, yellow onions; chopped onions; sliced onions; whole onions; garlic and types of garlic (fresh, grated, diced, crushed, whole, powdered, dried or) dehydrated; and shallots (chopped, sliced or whole).

### Side Dishes

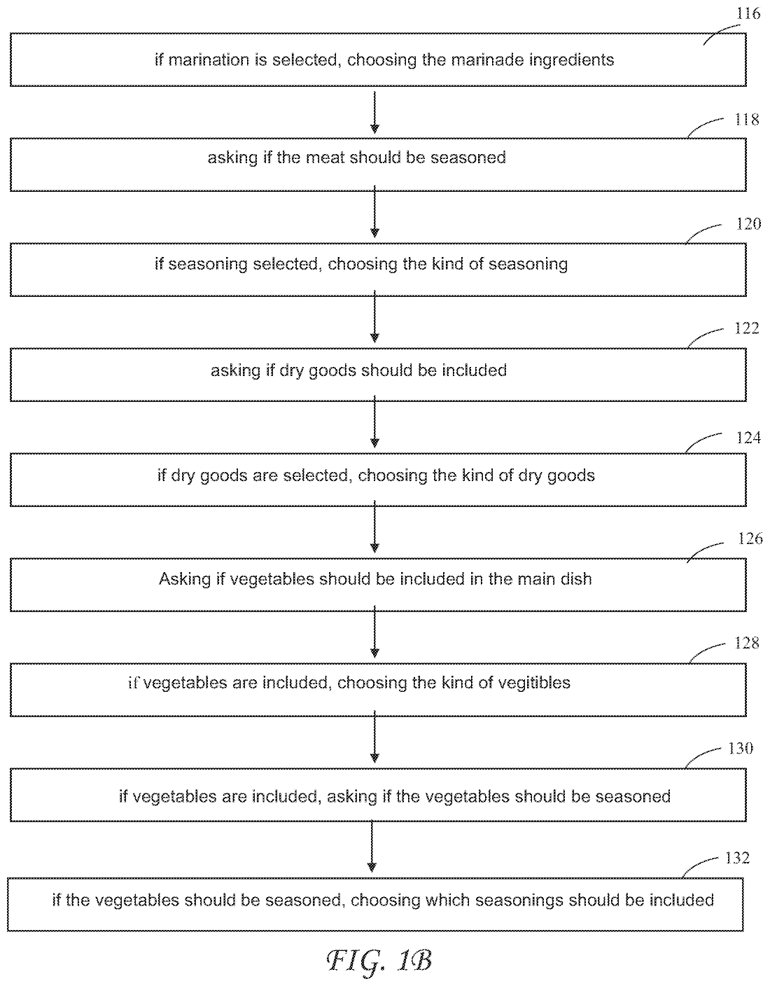

FIG. 2 shows a method further including asking if side dishes are included at step 134. If side dishes are included, choosing if side dishes include protein at step 136, choosing if side dishes include the vegetables at step 138, if side dishes include the vegetables, choosing if side dish vegetables are seasoned at step 140, and repeating options described above.

### Additional Items

FIG. 2 additionally shows a method further includes steps asking if the meal includes additional items at step 142. Choosing additional items may include, choosing if the additional items include extracts at step 144, for example, vanilla; choosing if the additional items include fruit or nuts at step 146, and choosing if the additional items include dough or pie shells at step 148.

### Recipe Adjustment

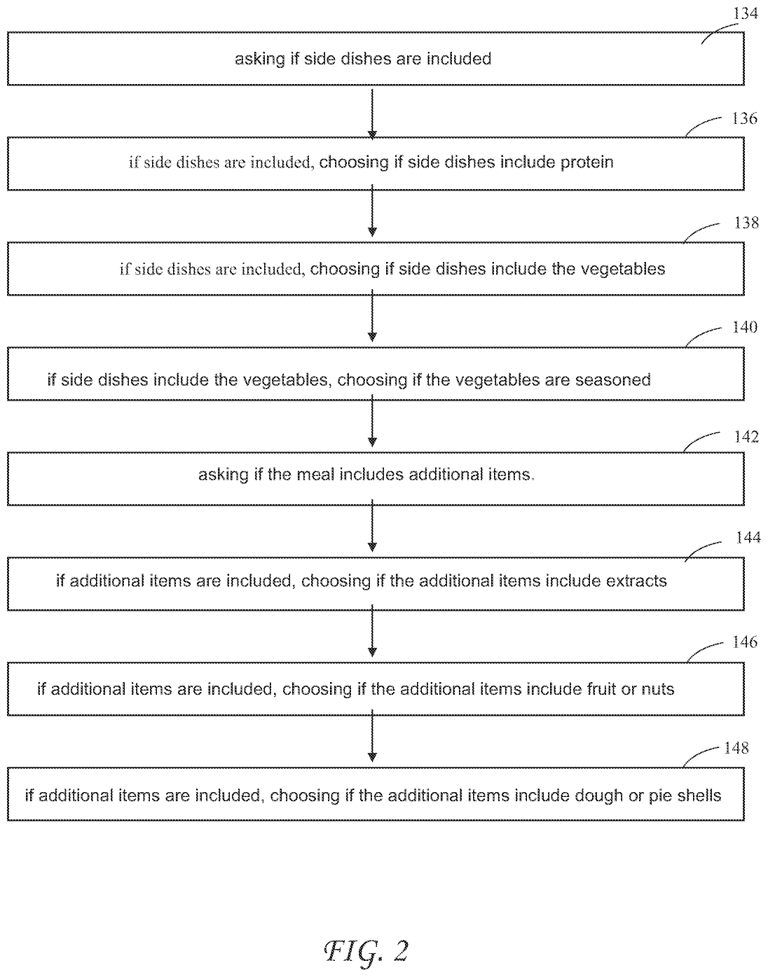

FIG. 3 shows a method of adjusting ingredients. The ingredients selected above are delivered to a customer at step 150. The customer prepares a meal using the ingredients at step 152. The customer adjusts the initial ingredient list based on the customer's preferences at step 154. The customer ordering adjusted meal ingredients based on the adjusted ingredient list at step 156.

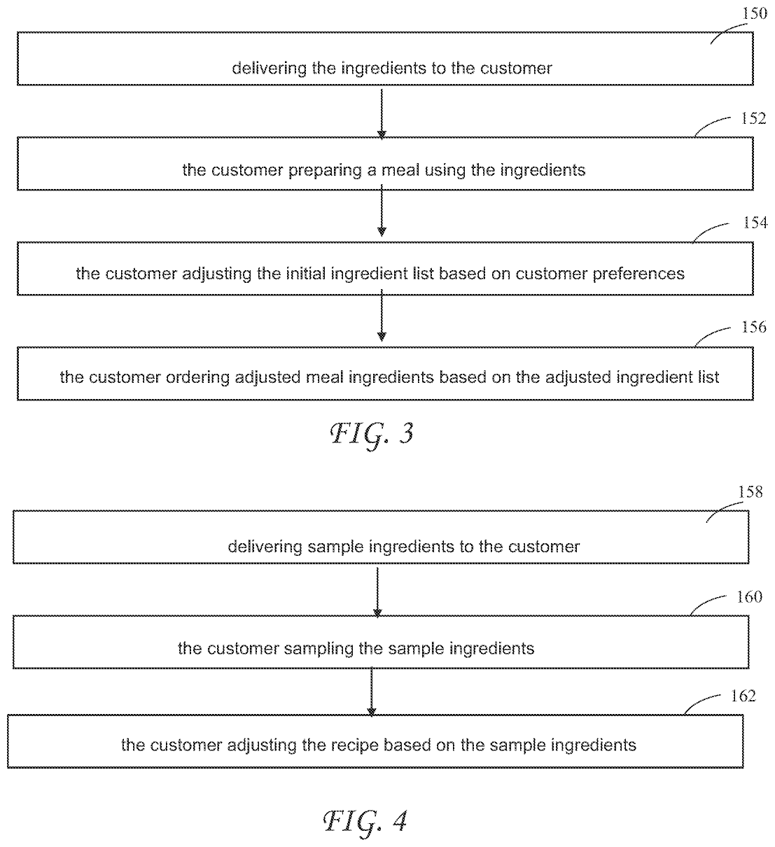

FIG. 4 shows a method for adjusting ingredients based on sample ingredients. The sample ingredients are delivered to the customer at step 158, the customer samples the sample ingredients at step 160, and the customer adjusts the recipe based on the sample ingredients at step 162.

The calories, fat, and carbohydrates of each of the ingredients may be provided. If the customer indicates a desire to reduce the calories, fat, or carbohydrates, suggested substitutes may be provided including the reduction in calories, fat, and carbohydrates. Samples may also be provided to facilitate the customers' selection substitutes.

### Example of Order

After the customer has selected their ingredients and preparation specifications, they will be provided with an order summary, for example:

order date: Nov. 17, 2020;
preparation time: (8 hrs.);
delivery time: Nov. 17, 2020 at 5 pm;
summary
protein choice:

beef

marination style:
dry seasoning:

salt, himalayan

pepper, black

garlic, fresh, diced

paprika, powder

onion, red, fresh, chopped and onion powder

vegetable accompanying protein, vegetable assortment, marinated, garlic herb;
side dishes: shrimp, marinated, herb blend;
dry seasoning blend: flour; garlic powder; onion powder; paprika; and
baked goods: chocolate pudding mix, cocoa, dried coconut, brown sugar, and vanilla extract.
Total customer time saved (8) hours of by obtaining meal ingredients using the present invention.

### Cosmetic Ingredient Services

The method described above for meal ingredients may also be adapted to cosmetic products. The process of ingredient customization for cosmetics allows an individual the opportunity to create their own recipe for cosmetic products, including but not limited to: toner; serums; foundation; powder; bronzer; lipstick; lipstick pencils; lotion; eyeliner; and mascara.

For example, a customer may selected and/or adjust individual ingredients in cosmetic products delivered to their home. The process and principles used in the customized ingredient preparation will also be utilized to allow the customer to individually select which cosmetic ingredients they would receive. Customers may specify makeup allergies, makeup hypersensitivities, or other adverse reactions to certain ingredients of cosmetic products ingredients and cosmetic products they receive may be filtered accordingly. The customer may select natural ingredients used to make cosmetic products more compatible with their skin.

Individuals will be able to use the app in the same way they can for food ingredients only they will be provided with cosmetic ingredients of their choosing, which can either be done via mobile or web app. The ingredients for each product will be pre-tested in all combinations available to ensure effectiveness.

### Curated Beauty Services

The methods of the present invention further allows the customer to select a wide variety of individualized beauty services from their choice of top professionals in each area of expertise. The customers selection is input into a website and/or mobile application where a returned curated experience is provided, including a detailed schedule, and combining services where possible. This method provides a decreased total amount of time by having the specialists come to the customer and follow our provided schedule. Each service is executed in an individual room at a designated facility where the curated services are completed by specialists. The client stays in one room and the specialists come to the client's room to complete the service, allowing individual specialists to work simultaneously but in a coordinated effort.

Select service options are able to be done in a customized mobile vehicle or the customer's home. The customer is provided with:

### an Initial Greeting

asking which services are requested in a drop down menu, for example:

hair;

nails;

skin;

massage;

chiropractic;

acupuncture; and

another specialty;

asking what kind of hair service are provided?
asking if the customer already has a stylist;
if the customer has a customer stylist, select the customer stylist;

if a customer stylist, the customer stylist sets a price once the customer arrives, based on the services, customer stylist may put minimum orders per service.

If the customer does not have a stylist, the customer may select service of:

haircut, men's or women's;
women's/men's hair options;
haircut;
styling;
haircut & styling;
hair repair treatment; and
coloring.
etc.
A list is provided and the customer selects haircut technician/stylist from the list.

The customer may select other services during the visit, selected from:

hair;
nails;
skin;
massage;
laser;
specialty;
nails;
manicure;
pedicure;
manicure/pedicure;
natural nails;
polish type, for example: gel or regular nail polish;
acrylic, for example gel, silk wrap, or regular nail polish;
specialty nail services;
select the nail technician.

The customer may select skin services selected from:

facial;
microdermabrasion;
chemical peels;
laser resurfacing;
laser skin rejuvenation;
acne blue light therapy; and
thermage.

The customer may select massage services selected from:

Swedish massage;
hot stone massage;
aromatherapy massage;
deep tissue massage;
sports massage;
trigger point massage;
reflexology; and
shiatsu massage.

The customer may select specialty services selected from:

salt scrub;
detoxifying body mask, for example seaweed/mud/algae;
hydrating body wrap;
serail mud chamber;
hot stone massage;
deep tissue massage; and
holistic full body massage.

After the customers has selected service, a summary of services and a custom schedule are provided. The customer may select to come to a designated facility provided by the present service provider, or a custom mobile vehicle, or at the customer's home. A summary of services, dates, and times is provided including:

date of service, for example Nov. 17 , 2020;
time of services, for example:

haircut & styling: 1:30 p to 2:30 p, with stylist name;

nails: 1:30 p to 2:30 p—with—nail technician name (combined service);
manicure/pedicure;
natural nails ;
polish type: gel;
specialty: 2:30 p to 3:30 p. Combined service—with: specialty therapist name;
hydrating body wrap;
massage: 3:30 p to 4:00 p (combined service);
deep tissue massage
skin: 4:00 p to 5:00 p (combined service); and
laser skin rejuvenation.
The customer saved 3.5 hours of by combining spa and salon services using the present invention. All of these options are customer facing and will be provided on a mobile application and/or a website.

While the invention herein disclosed has been described by means of specific embodiments and applications thereof, numerous modifications and variations could be made thereto by those skilled in the art without departing from the scope of the invention set forth in the claims.

I claim:

1. A method for providing customizable ingredient preparation & delivery to customers, comprising:
providing at least one initial ingredient list to a customer;
the customer selecting ingredients from the initial ingredient list;
delivering the ingredients to the customer based on the initial ingredient list;
the customer using the ingredients;
the customer adjusting the initial ingredient list based on customer preferences to obtain an adjusted ingredient list;
the customer ordering adjusted ingredients based on the adjusted ingredient list; and
delivering the adjusted ingredients to the customer based on the adjusted ingredient list.

2. The method of claim 1, wherein the ingredients are meal ingredients.

3. The method of claim 2, wherein the main dish ingredients include a type of protein.

4. The method of claim 2, wherein the type of protein is a meat protein.

5. The method of claim 4, further including selecting a marinate for the meat protein.

6. The method of claim 4, further including selecting a seasoning for the meat protein.

7. The method of claim 3, wherein selecting a type of protein comprises selecting a non-meat protein.

8. The method of claim 2, further including selecting a vegetable.

9. The method of claim 2, further including:
prior to delivering the ingredients to the customer, delivering sample ingredients to the customer;
the customer sampling the sample ingredients; and
the customer adjusting the recipe based on the sample ingredients.

10. The method of claim 2, further including:
providing a list of calories, fat, and carbohydrates in each ingredient;
providing a list of substitute ingredients to reduce the calories, the fat, or the carbohydrates in the recipe; and
the customer selecting substitute ingredients.

11. The method of claim 10, further including:
providing samples including the substitute ingredients;
the customer sampling the substitute ingredients;
the customer selecting from the substitute ingredients; and
delivering ingredients including the substitute ingredients.

12. The method of claim 1, wherein the ingredients are cosmetic ingredients.

13. The method of claim 10, further including:
the customer providing makeup allergies; and
adjusting the cosmetic ingredients to reduce or eliminate allergenic ingredients.

14. A method for providing customizable ingredient preparation & delivery to customers, comprising:
providing at least one initial ingredient list to a customer;
the customer selecting ingredients from the initial ingredient list;
providing a list of calories, fat, and carbohydrates in each ingredient;
providing a list of substitute ingredients to reduce the calories, the fat, or the carbohydrates in the recipe; and
the customer selecting substitute ingredients.
providing samples including the substitute ingredients;
the customer sampling the substitute ingredients;
the customer selecting from the substitute ingredients to modify the initial ingredient list; and
delivering ingredients based on the initial ingredient list;
the customer using the ingredients;
the customer adjusting the initial ingredient list based on customer preferences to obtain an adjusted ingredient list;
the customer ordering adjusted ingredients based on the adjusted ingredient list; and
delivering the adjusted ingredients to the customer based on the adjusted ingredient list.
